(19) United States
(12) Patent Application Publication
(10) Pub. No.: US 2018/0234294 A1
(43) Pub. Date: Aug. 16, 2018

(54) SYSTEM AND METHOD FOR CONFIGURING IOT DEVICES

(71) Applicant: Smartalyse Technologies Pvt. Ltd., Pune (IN)

(72) Inventors: Pravin Wadekar, Pune (IN); Satish Nikam, Pune (IN); Sunil Shilimkar, Pune (IN); Dhiraj Kulkarni, Pune (IN)

(21) Appl. No.: 15/867,280

(22) Filed: Jan. 10, 2018

(30) Foreign Application Priority Data
Feb. 13, 2017 (IN) 201721005109

(51) Int. Cl. H04L 12/24; H04L 29/08

(52) U.S. Cl. CPC H04L 41/0806; H04L 12/2807; H04L 67/12

(57) ABSTRACT

A system and a method are for configuring Internet-of-Things (IoT) devices in an IoT network. The system includes user equipment, a device controller and one or more IoT devices. The user equipment remotely configures and controls the IoT devices by way of the device controller. The method includes labeling the IoT devices by way of the device controller. The method provides for interoperability between a first communication standard of the IoT devices and a second communication standard of the user equipment.

### TECHNICAL FIELD

The present invention relates generally to computer systems and Internet-of-Things (IoT) networks, and, particularly but not exclusively, relates to configuration of IoT systems and devices.

### BACKGROUND

Internet-of-Things (IoT) is a network of interconnected physical objects. The physical objects within the IoT network are of various types (such as, but not limited to, home appliances, industrial appliances, and infrastructural components) and are connected by wired or wireless connections to facilitate sharing of data within the IoT networks and systems. The IoT networks are primarily used to detect and/or control physical parameters associated with the physical objects.

Conventionally, IoT is used on a large scale in wide-area applications such as smart factories, smart cities, smart grids, connected cars, supply chains, and retail. In smart factories, IoT is used to automate the manufacturing processes by enabling device-to-device communication. The devices communicate autonomously and wirelessly, detect faults, and communicate critical operational parameters to enable predictive maintenance before a fault occurs. This optimizes the manufacturing process and reduces strain on resources. In smart cities, the IoT enabled devices are used to detect and solve public problems such as air/noise pollution, traffic congestion, water treatment, electricity supply, maintenance of public infrastructure, and so on. The smart cities can, also function with smart grids, where IoT enabled power grids optimize the generation and distribution of electricity by detecting amount and pattern of usage of electricity within cities.

In small-area applications, IoT is used in connected health devices, home automation, wearable/biometric devices, and other such networks. In wearable device space, multiple sensors are used to measure one or more physical parameters about a user's health, activities, and other biological parameters. This data is used to provide uninterrupted connectivity to the user and to track health of the user. In home automation, connected home appliances such as lighting devices, entertainment devices, and kitchen appliances are connected to a device controller through a wired or wireless network. The device controller enables the user to control the home appliances. The conventional device controllers require the users to manually configure the IoT enabled home appliances.

In a conventional smart home system of IoT enabled home appliances, a registration controller is used to register the IoT enabled devices in the smart home system. The registration controller communicates with the IoT enabled home appliances and sends registration requests for registering the IoT enabled home appliances to a smart gateway. Thereafter, the smart gateway assigns registration codes to the IoT enabled home appliances. This requires the home appliances to be smart devices, i.e., to possess processing capability. This increases the cost of the system. Further, the conventional smart home system requires the user to input Unique Identification codes (UIDs) of the home appliances for configuring the home appliances. This makes the process of configuring the home appliances very tedious and time-consuming.

Therefore, there is a need for a method of configuring IoT devices which is quick, simple, and further, there is need for an IoT network that configures the IoT devices without the use of a registration controller and that configures both, smart and non-smart IoT devices.

### SUMMARY

This summary is provided to introduce concepts related to configuration of Internet-of-Things (IoT) devices and systems. This summary is neither intended to identify essential features of the present disclosure nor is it intended for use in determining or limiting the scope of the present disclosure.

Accordingly, the present invention provides one or more embodiments in an Internet-of-Things (IoT) network for configuring one or more IoT devices.

In an embodiment of the present invention, a method implemented by a device controller in, an Internet-of-Things (IoT) network for enabling configuration of a plurality of IoT devices in the IoT network is provided. The method includes identifying a plurality of Unique Identification Codes (UIDs) corresponding to the plurality of devices and storing the plurality of UIDs in a memory coupled with the device controller. Thereafter, the device controller includes a first state change signal from a bridge. The first state change signal includes a first UID corresponding to the first device. The first state change signal is indicative of change in state of a first device. The device controller transmits the first state change signal to the user equipment and receives a first semantic label from the user equipment in response to transmitting the first state change signal. The method further includes storing the first semantic label in the memory and labelling the first device. The first semantic label corresponds to the first device.

In an embodiment of the present invention, a method implemented by a device controller for establishing interoperability between a plurality of devices communicating in a first communication standard and a user equipment communicating in a second communication standard is provided. The method includes storing a plurality of Unique Identification Codes (UIDs) in a memory coupled to the device controller. The plurality of UIDs correspond to the plurality of devices. The method further includes storing a plurality of semantic labels in the memory. The plurality of semantic labels correspond to the plurality of devices. Thereafter, the device controller receives a first command signal, from the user equipment, in the second communication standard. The first command signal includes a semantic label and an instruction. The device controller determines a UID corresponding to the semantic label. The UID corresponds to a device of the plurality of devices. The device controller generates a second command signal. The second command signal includes the UID and the instruction. The device controller transmits the second command signal to a bridge in the first communication standard. The bridge is in communication with the device in the first communication standard, thereby establishing interoperability between the user equipment and the plurality of devices. The user equipment, is configured to transmit a request for discovering the plurality of IoT devices to the device controller. The device controller is configured to, receive the request from the user equipment, identify the plurality of UIDs corresponding to the plurality of IoT devices, and transmit the plurality of the UIDs to the user equipment. The device controller further receives the first state change signal from the IoT bridge and generates an event notification based on the first state change signal. Thereafter, the device controller transmits the event notification to the user equipment. The event notification is rendered on a display of the user equipment and a user of the user equipment is prompted to input a semantic label for the first IoT device in response to the rendered event notification, thereby configuring the first IoT device.

In an embodiment, an Internet-of-Things (IoT) configuration system is provided. The IoT configuration system includes a plurality of IoT devices, an IoT bridge, a user equipment, and, a device controller. The plurality of IoT devices have a plurality of Unique Identification Codes (UIDs). A first IoT device of the plurality of IoT devices is configured to generate a first state change signal that indicates change in state of the first IoT device. The IoT bridge is configured to receive the first state change signal from the first IoT device and transmit the first state change signal to the device controller. The user equipment is configured to transmit a request for discovering the plurality of IoT devices. The device controller is configured to receive the request from the user equipment, identify the plurality of UIDs corresponding to the plurality of IoT devices, and, transmit the plurality of the UIDs to the user equipment. The device controller is further configured to receive the first state change signal from the IoT bridge, generate an event notification based on the first state change signal, and transmit the event notification, to the user equipment. The event notification is rendered on a display of the user equipment. A user of the user equipment is prompted to input a semantic label for the first IoT device in response to the rendered event notification, thereby configuring the first IoT device.

### BRIEF DESCRIPTION OF THE ACCOMPANYING DRAWINGS

The detailed description is described with reference to the accompanying figures. In the figures, the left-most digit(s) of a reference number identifies the figure in which the reference number first appears. The same numbers are used throughout the drawings to reference like features and modules.

FIG. 1 illustrates a schematic block diagram of an Internet-of-Things (IoT) configuration system in accordance with an embodiment of the present invention.

FIG. 2 illustrates a schematic block diagram of an IoT configuration system in accordance with an embodiment of the present invention.

FIG. 3 illustrates a schematic block diagram of a device controller in an IoT configuration system in accordance with an embodiment of the present invention.

FIG. 4 illustrates a schematic block diagram of an IoT bridge in an IoT configuration system in accordance with an embodiment of the present invention.

FIG. 5 illustrates a flowchart depicting a method of labeling an IoT device in an IoT configuration system in accordance with an embodiment of the present invention.

FIG. 6 illustrates a flowchart depicting a method of establishing interoperability between a user equipment and one or more IoT devices in an IoT configuration system in accordance with an embodiment of the present invention.

FIGS. 7A and 7B collectively illustrates a flowchart depicting a method of enabling communication between a user equipment and one or more IoT devices in an IoT configuration, system in accordance with an embodiment of the present invention.

It should be appreciated by those skilled in the art that any block diagrams herein represent conceptual views of illustrative systems embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Although specific terms are used in the following description for the sake of clarity, these terms are intended to refer only to the particular structure of the invention selected for illustration in the drawings, and are not intended, to define or limit the scope of the invention.

Further, the systems and methods are not limited to the specific embodiments described herein. In addition, modules of each system and each method can be practiced independently and separately from other modules and methods described herein. Each module and method can be used in combination with other modules and other methods.

According to an implementation, the present invention relates to an Internet-of-Things (IoT) configuration system. The IoT configuration system includes a user equipment, a device controller, an IoT bridge and multiple IoT devices. The IoT bridge is in communication with the IoT devices by way of a first communication standard (For instance, Z-Wave, Thread, ZigBee, Bluetooth LE, etc.). The device controller is in communication with the user equipment by way of a second communication standard (For instance, Wi-Fi etc.).

The user equipment is configured to send a request to the device controller for identifying the IoT devices. The device controller obtains Unique Identification Codes (UIDs) corresponding to the IoT devices by way of the IoT bridge. The device controller transmits the UIDs to the user equipment. The user equipment displays the UIDs to a user of the user equipment by way of a display of the user equipment.

The IoT devices are configured, to transmit a state change signal to the device controller when the IoT devices change state. In an example, a first IoT device changes state (For instance, switching ON/OFF, entering STANDBY/SLEEP mode, etc.) and transmits a first state change signal to the IoT bridge in the first communication standard. The first state change signal includes a first UID of the first IoT device. The IoT bridge receives and transmits the first state change request to the device controller in the second communication standard. The device controller receives the first state change signal and transmits the first state change signal to the user equipment in the second communication standard. The user equipment receives the first state change signal and displays the same to the user. In response, the user inputs a first semantic label for the first IoT device. The first semantic label is transmitted by the user equipment to the device controller. The device controller receives and stores the first semantic label in a memory coupled with the device controller. In an, example, the device controller creates and stores a look-up table of the UIDs and one or more semantic labels corresponding to the IoT devices. The device controller determines a UID corresponding to a semantic label or determines the semantic label corresponding to the UID based on the look-up table. Thus, the IoT configuration system of the present invention configures the first IoT device by storing the first semantic label corresponding to the first IoT device.

In another embodiment of the present invention, the user equipment transmits a first command signal to the device controller in the second communication standard. The first command signal includes the first semantic label and a first instruction for the first IoT device. The device controller receives the first command signal and reads the first semantic label within the first command signal. The device controller determines the first UID based on the look-up table stored in the memory. Thereafter, the device controller transmits the first instruction and the first UID to the IoT bridge. Alternatively, the device controller transmits the first command signal and the first UID to the IoT bridge. The IoT bridge then transmits the first instruction to the first IoT device. In an example, the first IoT device changes state after receiving and executing the first instruction and subsequently re-generates and re-transmits the first state change signal to the IoT bridge to provide an indication to the IoT bridge about latest change in state of the first IoT device. Thus, the IoT configuration system of the present invention enables the user of the user equipment to remotely change states of the IoT devices by way of the device controller and the IoT bridge. Further, the IoT configuration system ensures interoperability between the first and second communication standards.

In another implementation, for a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes and programs can be stored in a memory and executed by a processor.

In another firmware and/or software implementation, the functions may be stored as one or more instructions or code on a non-transitory computer-readable medium. Examples include computer-readable media encoded with a data structure and computer-readable media encoded with a computer program. The computer-readable media may take the form of an article of manufacturer. The computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk, and Blue-ray disc where disks usually reproduce data magnetically, while discs reproduce data optically with lasers. Combinations of the above should also be included within the scope of computer-readable media.

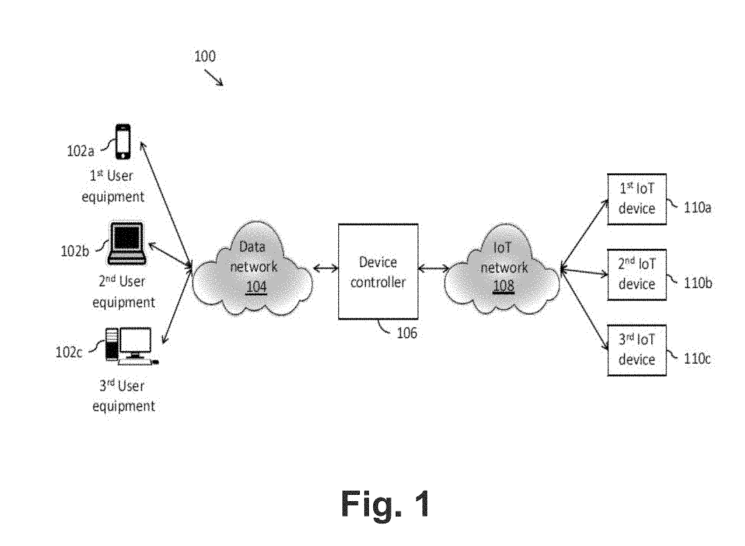

Referring now to FIG. 1, a schematic block diagram of an IoT configuration system (100) in accordance with an embodiment of the present invention is shown. The IoT configuration system (100) includes first through third user equipments (102a-102c) collectively referred to as “the user devices (102)” or singularly referred to as “the user device (102)”, a data network (104), a device controller (106), an IoT network (108), and a plurality of IoT devices including first through third IoT devices (110a-110c) collectively referred to as “the IoT devices (110)” or singularly referred to as “the IoT device (110)”.

The IoT devices (110) are in communication with the device controller (106) by way of the IoT network (108). The IoT devices (110) communicate in a first communication standard. Examples of the first communication standard include, but are not limited to, Z-Wave, Thread, ZigBee, Bluetooth LE, etc. Each IoT device (110) has a corresponding Unique Identification Code (UID). The UID is used to uniquely identify corresponding IoT device (110).

Examples of the user equipments (102) include, but are not limited to electronic devices, such as, smart phones, laptops, Personal Computers (PCs), remote controllers, etc. The user equipments are in communication with the device controller (106) by way of the data network (104). The user equipments (102) communicate in a second communication standard, such as but not limited to, Wi-Fi.

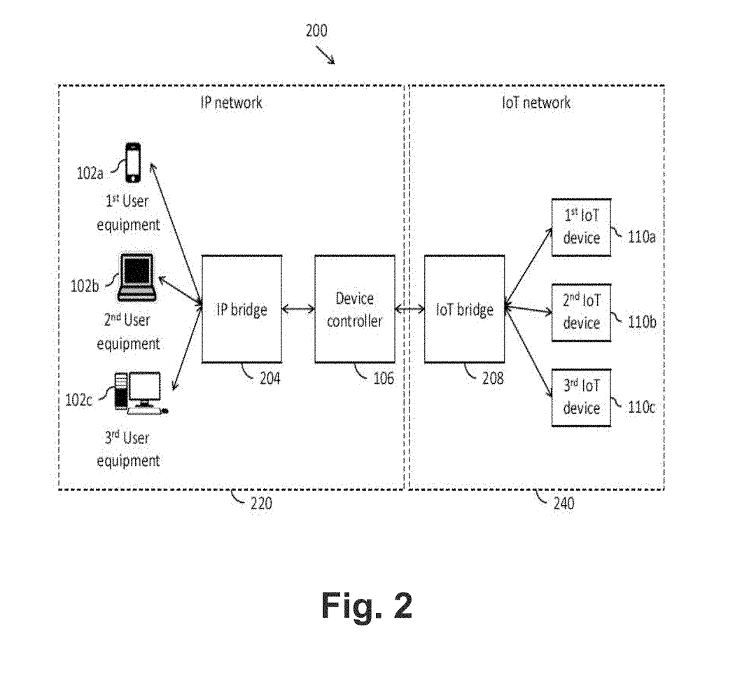

Referring now to FIG. 2, a schematic block diagram of an IoT configuration system (200) in accordance with an embodiment of the present invention is shown. In an embodiment, the IoT configuration system (200) is a detailed schematic block, diagram of the IoT configuration system (100).The IoT configuration system (200) includes the user equipments (102), an Internet Protocol (IP) bridge (204), the device controller (106), an IoT bridge (208), and the IoT devices (110).

The user equipments (102) are in communication with the IP bridge (204) in, the second communication standard. The IP bridge (204) is connected to the device controller (106) by way of wired or wireless communication networks. The device controller (106) is connected to the IoT bridge (208) by way of wired or wireless communication networks. The IoT bridge (208) is in communication with the IoT devices (110) in the first communication standard.

In an example, the user equipments (102), the IP bridge (204), and the device controller (106) employ IP protocol and hence form an IP network (220). The IoT bridge (208) and the IoT devices (110) employ IoT protocols and hence form an IoT network (240). The user equipment (102) sends a request to the IP bridge (204) for discovering the IoT devices (110) in the second communication standard. The IP bridge (204) receives and transmits the request to the device controller (106) in, the second communication standard.

The device controller (106) receives and transmits the request to the IoT bridge (208). In response to receiving the request, the IoT bridge (208) transmits the UIDs corresponding to the IoT devices (110) to the device controller (106). The device controller (106) transmits the UIDs to the user equipment (102).The user equipment (102) displays the UIDs to a user of the user equipment (102) by way of a display device of the user equipment (102).

Further, the first IoT device (110a) generates and transmits a first state change signal to the IoT bridge (208) in the first communication standard. The first state change signal is indicative of change in state of the first IoT device (110a) and includes a first UID corresponding to the first IoT device (110a). The IoT bridge (208) receives the first state change signal and sends the first state change signal, to the device controller (106). The device controller (106) then transmits the first state change signal to the user equipment (102). The user equipment (102) displays the change in state of the first IoT device (110a) to the user. In an example, the user equipment (102) prompts the user to enter a first semantic label corresponding to the first IoT device (110a). The user equipment (102) then transmits the, first semantic label to the device controller (106) by way of the IP bridge (204). The device controller (106) receives and stores the first semantic label in corresponding to the first IoT device (110a), thereby labeling the first IoT device (110a).

Further, the user equipment (102) generates and transmits a first command signal to the device controller (106) by way of the IP bridge (204). The first command signal includes the first semantic label and a first instruction. The device controller (106) receives the first command signal and retrieves the first semantic label from the first command signal. The device controller (106) further determines the first UID corresponding to the first semantic label and generates a second command signal including the first instruction and the first UID. The device controller (106) transmits the second command signal to the IoT bridge (208). The IoT bridge (208) transmits the first instruction to the first IoT device (110a) based on the received second command signal.

In an exemplary embodiment, the first IoT device (110a) receives the first instruction, executes the first instruction, changes state thereof and re-generates the first state change signal. The first IoT device (110a) transmits the first state change signal to the IoT bridge (208). The IoT bridge (110a) transmits the re-generated first state change signal to the device controller (106).

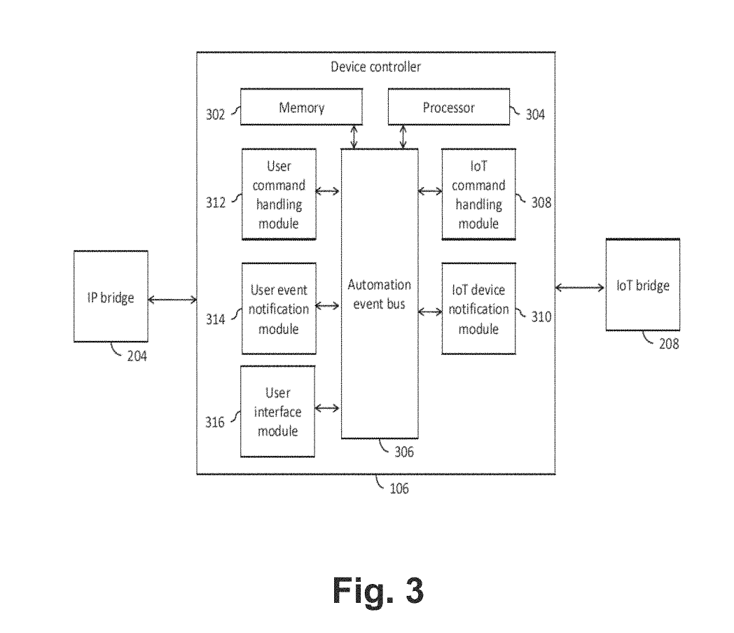

Referring now to FIG. 3, a schematic block diagram of the device controller (106) in accordance with an embodiment of the present invention is shown. The device controller (106) includes a memory (302), a processor (304), and an automation event bus (306). The device controller (106) further includes an IoT command handling module (308), an IoT device notification module (310), a user command handling module (312), a user event notification module (314), and a user interface module (316), collectively referred to as “the modules (308-316)”.

In an implementation, the device controller 106may include any types of memory 302. The memory 302 may be coupled to the processor 304. The memory 302 can include any computer-readable medium known in the art including, for example, volatile memory, such as static random access memory (SRAM) and dynamic random, access memory (DRAM), and/or non-volatile memory, such as read only memory (ROM), erasable programmable ROM, flash memories, hard disks, optical disks, and magnetic tapes.

In another, implementation, the device controller 106 includes any type of processor(s) 304. The processor 304 may be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in a memory 208.

In another embodiment, the automation event bus (306) and the modules (308-316) are software modules stored in the memory (302) and are executed by the processor (304). In the present embodiment, the user interface module (316) receives the request from the user equipment (102) and sends the request to the processor (304). Thereafter, the IoT device notification module (310) receives the UIDs corresponding to the IoT devices (110) from the IoT bridge (208). The processor (304) stores the UIDs in the memory (302) and thereafter transmits the UIDs to the user equipment (102).

The IoT device notification module receives (310) the first state change signal from the first IoT device (110a) by way of the IoT bridge (208). The processor (304) transmits the first state change signal to the user equipment (102) by way of the user event notification module (314).

Thereafter, the user command handling module (312) receives the first semantic label from the user equipment (102) and the processor (304) stores the first semantic label in the memory (302). In an example, the processor (304) stores a look-up table in the memory (302). The look-up table includes multiple semantic labels corresponding to the IoT devices (110) and multiple UIDs corresponding to the IoT devices (110).

Further, the user command handling module (312) receives the first command signal from the user equipment (102). The first command signal includes the first semantic label and the first instruction. The processor (304) retrieves the first semantic label from the first command signal and determines the first UID corresponding to the first semantic label based on the look-up table stored in the memory (302). The processor (304) then generates the second command signal that includes the first UID and the first instruction. The IoT command handling module (308) transmits the second command signal to the first IoT device (110a).

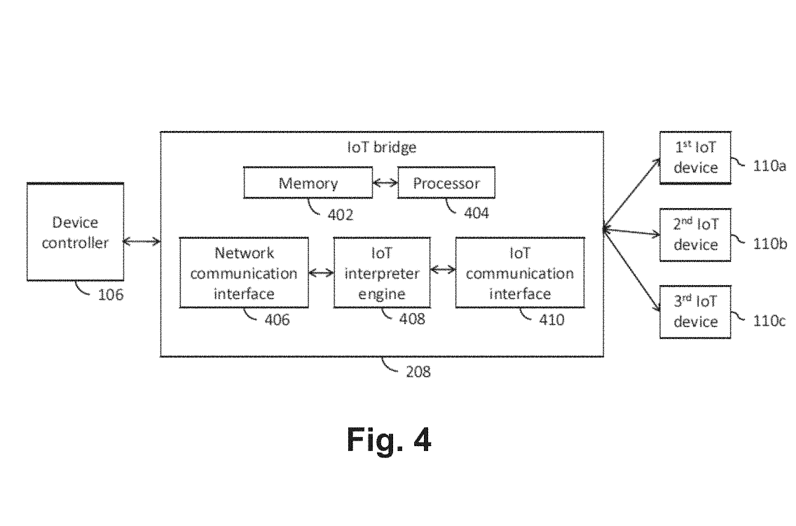

Referring now to FIG. 4, a schematic block diagram of the IoT bridge (208) in accordance with an embodiment of the present invention is shown. The IoT bridge includes a memory (402), a processor (404), a network communication module (406), an IoT interpreter engine (408), and an IoT communication interface (410).

The IoT communication interface (410) communicates with the IoT devices (110) in the first communication standard. In an example, the IoT communication interface transmits the first command signal to the first IoT device (110a) and receives the first state change signal from the first IoT device (110a).

The network communication interface (406) communicates with the device controller (106) in the second communication standard. In an example, the network communication interface (406) receives the request and the second command signal from the device controller (106).

The IoT interpreter engine (408) interprets the received request and the second command signal and accordingly transmits the first instruction to the first IoT device (110a) by way of the IoT communication interface (410).

In operation, the user equipment (102) sends the request to the device controller (106) for identifying the IoT devices (110). The device controller (106) obtains the UIDs corresponding to the IoT devices (110) by way of the IoT bridge (208). The device controller (110) transmits the UIDs to the user equipment (102). The user equipment (102) displays the UIDs to the user of the user equipment (102) by way of the display of the user equipment (102).

The IoT devices (110) are configured to transmit state change signals to the device controller (106) when corresponding IoT devices (110) change state. In an example, the first IoT device (110a) changes state and transmits the first state change signal to the IoT bridge (208) in the first communication standard. The first state change signal includes the first UID of the first IoT device (110a). The IoT bridge (208) receives and transmits the first state change request to the device controller (106) in the second communication standard. The device controller (106) receives the first state change signal and transmits the first state change signal to the user equipment (102) in the second communication standard. The user equipment (102) receives the first state change signal and displays the same to the user. In response, the user inputs the first semantic label for the first IoT device (110a). The first semantic label is transmitted by the user equipment (102) to the device controller (106). The device controller (106) receives and stores the first semantic label in the memory (302). In an example, the device controller (106) creates and stores the look-up table of the UIDs and one or more semantic labels corresponding to the IoT devices (110) in the memory (302). Thus, the IoT configuration system (200) of the present invention configures the first IoT device (110a).

The user equipment (102) transmits the first command signal to the device controller (106) in the second communication standard. The first command signal includes the first semantic label and the first instruction for the first IoT device (110a). The device controller (106) receives the first command signal and reads the first semantic label within the first command signal. The device controller (106) determines the first UID based on the look-up table stored in the memory (302). Thereafter, the device controller (106) transmits the first instruction and the first UID to the IoT bridge (208). Alternatively, the device controller (106) transmits the first command signal and the first UID to the IoT bridge (208). The IoT bridge (208) then transmits the first instruction to the first IoT device (110a). In an example, the first IoT device (110a) changes state after receiving and executing the first instruction and subsequently re-generates and re-transmits the first state change signal to the IoT bridge (208) to provide an indication to the IoT bridge (208) about latest change in state of the first IoT device (110a).

Thus, the IoT configuration system (200) of the present invention identifies the UIDs of the IoT devices (110), groups the IoT devices (110) based on physical location of the IoT devices (110), labels the groups by assigning semantic group labels to the groups, and stores mapping of the groups and the IoT devices (110) in the device controller (106), thereby presenting the IoT devices (110) to the user of the user equipment (102) in an organized fashion.

The IoT configuration system (200) of the present invention enables the user of the user equipment (102) to remotely change states of the IoT devices (110) by way of the device controller (106) and the IoT bridge (208). Further, the IoT configuration system (200) ensures interoperability between the first and second communication standards.

In an embodiment, the user equipment (102) enables the user to create one or more groups of the IoT devices (110) on a user interface of the user equipment (102). Further, the user equipment (102) also enables the user of the user equipment (102) to label the groups by a semantic group label. In an example, the user equipment (102) receives a first semantic group label for a first group of IoT devices (110) created by the user and thereafter transmits the first semantic group label to the device controller (106). The device controller (106) receives and stores the first semantic group label in the memory (302).

In an embodiment, the user equipment (102) also displays an option to test the IoT devices (110). While testing the IoT devices (110), the user sends one or more testing commands to the IoT devices (110) through the user equipment (102). The testing commands include instructions executable by the IoT devices (110). Examples of the testing commands include, but are not limited to, switch ON and switch OFF. Further, the testing commands may vary based on the type of the IoT devices (110). In an example, the user equipment (102) displays the testing commands and the UIDs of the IoT devices (110).

This enables the user to determine which of the IoT devices (110) are being configured by the user. This also avoids interference between two or more users configuring the IoT devices (110) at the same time and at the same location. In an example, the user tests the IoT devices (110) before labeling the IoT devices (110).

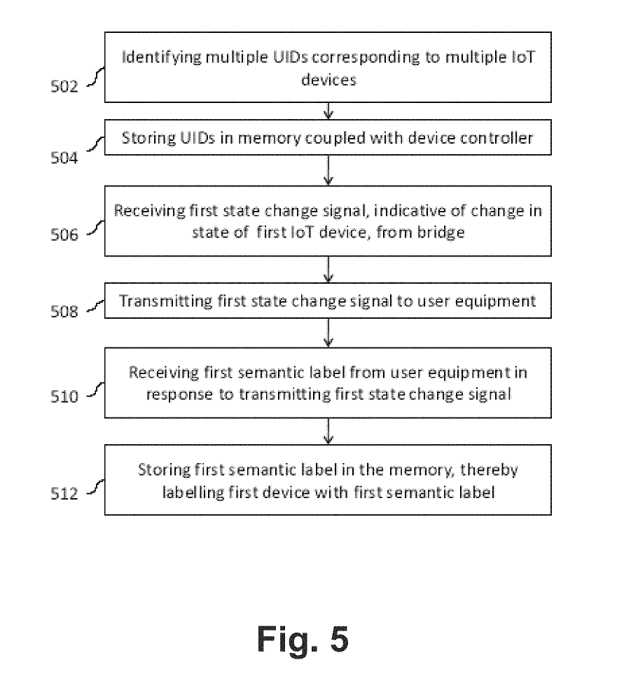

Referring now to FIG. 5, a flowchart depicting a method of labeling the IoT device (110) in the IoT configuration system (200) in accordance with an embodiment of the present invention is shown.

At step 502, the device controller (106) identifies the UIDs corresponding to the IoT devices (110).

At step 504, the device controller (106) stores the UIDs in the memory (302).

At step 506, the device controller (106) receives the first state change signal from the IoT bridge (208). The first state change signal is indicative of change in state of the first IoT device (110a).

At step 508, the device controller (106) transmits the first state change signal to the user equipment (102).

At step 510, the device controller (106) receives the first semantic label from the user equipment (102) in response to transmitting the first state change signal.

At step 512, the device controller (512) stores the first semantic label in the memory (302), thereby labeling the first IoT device (110a).

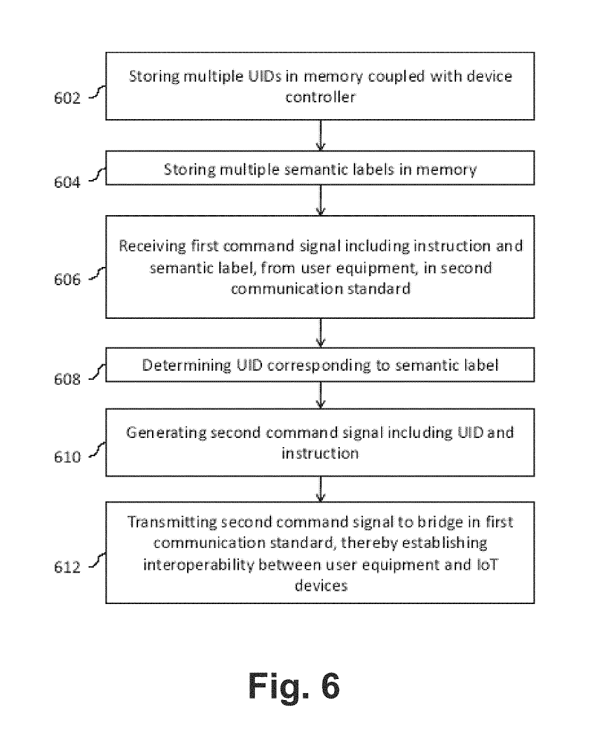

Referring now to FIG. 6 a flowchart depicting a method of establishing interoperability between the user equipment (102) and the IoT devices (110) in the IoT configuration system (200) in accordance with an embodiment of the present invention is shown.

At step 602, the device controller (106) stores the UIDs in the memory (302).

At step 604, the device controller (106) stores the semantic labels in the memory (302).

At step 606, the device controller (106) receives the first command signal from the user equipment (102). The first command signal includes the first semantic label and the first instruction in the second communication standard.

At step 608, the device controller (106) determines the first UID corresponding to the first semantic label.

At step 610, the device controller (106) generates a second command signal. The second command signal includes the first UID and the first instruction.

At step 612, the device controller (106) transmits the second command signal to the IoT bridge (208) in the first communication standard, thereby establishing interoperability between the user equipment (102) and the IoT devices (110).

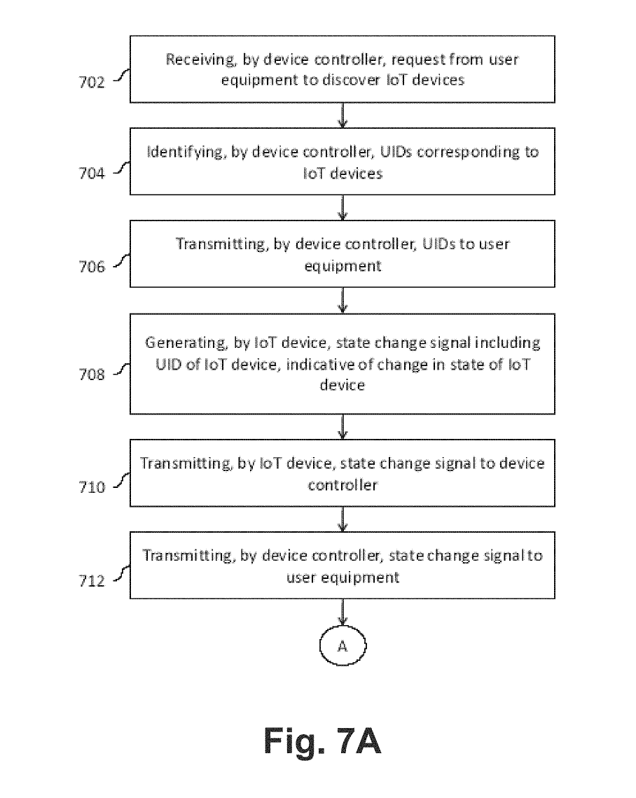

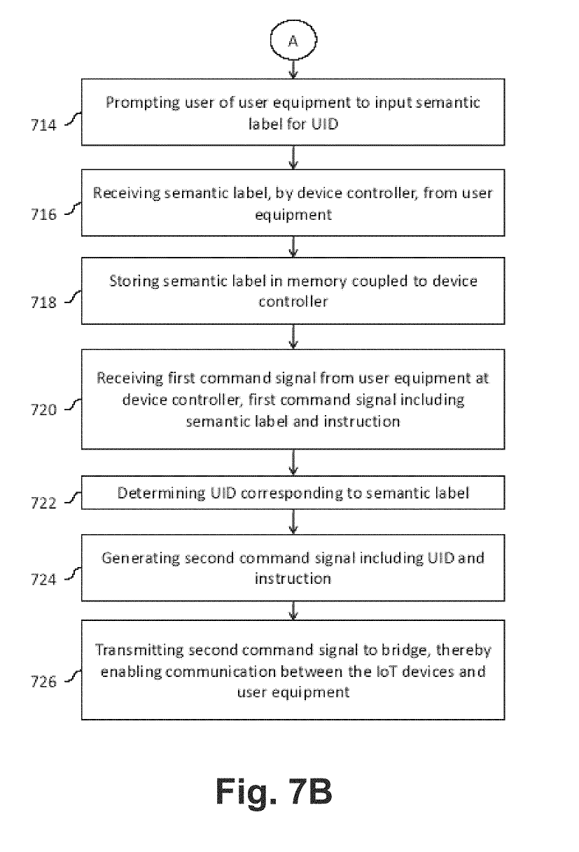

Referring now to FIGS. 7A and 7B are a flowchart depicting a method of enabling communication between the user equipment (102) and the IoT devices (110) in the IoT configuration system (200) in accordance with an embodiment of the present invention is shown.

At step 702, the device controller (106) receives the request from the user equipment (102) to discover the IoT devices (110).

At step 704, the device controller (106) identifies the UIDs corresponding to the IoT devices (110).

At step 706, the device controller (106) transmits the UIDs to the user equipment (102).

At step 708, the first IoT device (110a) generates the first state change signal indicative of change in state of the firs IoT device (110a).

At step 710, the first IoT device (110a) transmits the first state change signal to the device controller (106).

At step 712, the device controller (106) transmits the first state change signal to the user equipment (102).

At step 714, the user equipment (102) prompts the user to input the first semantic label corresponding to the first IoT device (110a).

At step 716, the device controller (106) receives the first semantic label from the user equipment (102).

At step 718, the device controller (106) stores the first semantic label in the memory (302).

At step 720, the device controller (106) receives the first command signal from the user equipment (102). The first command signal includes the first semantic label and the first instruction.

At step 722, the device controller (106) determines the first UID corresponding to the first semantic label and thereby corresponding to the first IoT device (110a).

At step 724, the device controller (106) generates and transmits the second command signal to the IoT bridge (208), thereby enabling the communication between the user equipment (102) and the IoT devices (110).

Therefore, the IoT configuration system (200) of the present invention and the abovementioned methods implemented in the IoT configuration system (200) provide an easy to use method of labeling, configuring, and controlling the IoT devices without the necessity of utilizing the UIDs of the IoT devices (110). Therefore, the IoT configuration system (200) of the present invention and the abovementioned methods enable the user to utilize the IoT devices (110) without requiring the technical knowledge about the IoT devices (110). This simplifies the process and reduces costs of configuring the IoT devices (110), thereby overcoming the shortcomings of conventional IoT configuration, systems.

The foregoing description of the invention has been set merely to illustrate the invention and is not intended to be limiting. Since modifications of the disclosed embodiments incorporating the substance of the invention may occur to person skilled in the art, the invention should be construed to include everything within the scope of the invention.

It should be noted that the description merely illustrates the principles of the present invention. It will thus be appreciated that those skilled in the art will be able to devise various arrangements that, although not explicitly described herein, embody the principles of the present invention. Furthermore, all examples recited herein are principally intended expressly to be only for explanatory purposes to help the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. A method implemented by a device controller in an Internet-of-Things (IoT) network for enabling configuration of a plurality of devices in the IoT network, the method comprising:
identifying a plurality of Unique Identification Codes (UIDs) corresponding to the plurality of devices;
storing the plurality of UIDs in a memory coupled with the device controller;
receiving a first state change signal from a bridge, wherein the first state change signal is indicative of change in state of a first device, and wherein the first state change signal includes a first UID corresponding to the first device;
transmitting the first state change signal to a user equipment;
receiving a first semantic label from the user equipment in response to said transmitting of the first state change signal; and
storing the first semantic label in the memory, wherein the first semantic label corresponds to the first device, thereby labelling the first device.

2. The method as claimed in claim 1, wherein the plurality of devices are IoT devices.

3. The method as claimed in claim 1, further comprising testing the plurality of devices.

4. A method implemented by a device controller for establishing interoperability between a plurality of devices communicating in a first communication standard and a user equipment communicating in a second communication standard, the method comprising:
storing a plurality of Unique Identification Codes (UIDs) in a memory coupled to the device controller, wherein the plurality of UIDs correspond to the plurality of devices;
storing a plurality of semantic labels in the memory, wherein the plurality of semantic labels correspond to the plurality of devices;
receiving a first command signal, from the user equipment, in the second communication standard, wherein the first command signal includes a semantic label and an instruction;
determining a UID corresponding to the semantic label, wherein the UID corresponds to a device of the plurality of devices;
generating a second command signal, wherein the second command signal includes the UID and the instruction; and
transmitting the second command signal to a bridge in the first communication standard, wherein the bridge is in communication with the device in the first communication standard, thereby establishing interoperability between the user equipment and the plurality of devices.

5. The method as claimed in claim 4, wherein the plurality of devices are IoT devices.

6. The method as claimed in claim 4, further comprising testing the plurality of devices.

7. A method for enabling communication between a plurality of devices in an Internet-of-Things (IoT) network and a user equipment, the method comprising:
receiving, by a device controller, a request from the user equipment to discover the plurality of devices;
identifying, by the device controller, a plurality of Unique Identification Codes (UIDs) corresponding to the plurality of devices;
transmitting, by the device controller, the plurality of the UIDs to the user equipment;
generating, by a device, a state change signal, wherein the state change signal is indicative of change in state of the device, and wherein the state change signal includes a UID of the device;
transmitting, by the device, the state change signal to the device controller;
transmitting, by the device controller, the state change signal to the user equipment;
prompting a user of the user equipment to input a semantic label for the UID;
receiving the semantic label, by the device controller, from the user equipment;
storing the semantic label in a memory coupled to the device controller;
receiving a first command signal from the user equipment at the device controller, wherein the first command signal includes the semantic label and an instruction;
determining the UID corresponding to the semantic label;
generating a second command signal, wherein the second command signal includes the UID and the instruction; and
transmitting the second command signal to a bridge, wherein the bridge is in communication with the device, thereby enabling communication between the plurality of devices and the user equipment.

8. The method as claimed in claim 7, wherein the plurality of devices are IoT devices.

9. The method as claimed in claim 7, further comprising testing the plurality of devices.

10. An Internet-of-Things (IoT) configuration system, comprising:
a plurality of IoT devices having a plurality of Unique Identification Codes (UIDs), wherein a first IoT device of the plurality of IoT devices is configured to generate a first state change signal, and wherein the first state change signal indicates change in state of the first IoT device;
an IoT bridge in communication with the plurality of IoT devices including the first IoT device, wherein the IoT bridge is configured to receive the first state change signal from the first IoT device and transmit the first state change signal;
a user equipment configured to transmit a request for discovering the plurality of IoT devices; and
a device controller in communication with the user equipment and the IoT bridge, wherein the device controller is configured to:
receive the request from the user equipment;
identify the plurality of UIDs corresponding to the plurality of IoT devices;
transmit the plurality of the UIDs to the user equipment;
receive the first state change signal from the IoT bridge;
generate an event notification based on the first state change signal, and
transmit the event notification to the user equipment,
wherein the event notification is rendered on a display of the user equipment, and wherein a user of the user equipment is prompted to input a semantic label for the first IoT device in response to the rendered event notification, thereby configuring the first IoT device.

11. The IoT configuration system as claimed in 10, wherein the device controller comprises:
a memory that stores one or more instructions;
a processor coupled to the memory and configured to read and execute the one or more instructions;
an IoT command handling module configured to send one or more commands to the plurality of IoT devices;
an IoT device notification module configured to receive the first state change signal from the first IoT device;
a user command handling module configured to receive one or more commands from the user equipment, and
a user event notification module configured to send the event notification the user equipment.

12. The IoT configuration system as claimed in claim 10, wherein the IoT configuration system is configured to group the IoT devices based on physical location of the IoT devices.

13. The IoT configuration system as claimed in claim 10, wherein the user equipment enables the user to create one or more groups of the IoT devices on a user interface of the user equipment.

14. The IoT configuration system as claimed in claim 10, wherein the IoT configuration system is configured to test the plurality of IoT devices.
